(19) United States
(12) Patent Application Publication
(10) Pub. No.: US 2006/0234677 A1
(43) Pub. Date: Oct. 19, 2006

(54) METHOD FOR CHANNEL CONTROL WITH WIRELESS TRANSMISSION

(76) Inventors: Chun-Gu Lin, Taipei City (TW); Yi-Hung Shen, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/161,255

(22) Filed: Jul. 28, 2005

(30) Foreign Application Priority Data
Apr. 13, 2005 (TW) 94111616

(51) Int. Cl. H04M 1/66

(52) U.S. Cl. 455/411

(57) ABSTRACT

A method for channel control with wireless transmission is provided, in which a receiver is adopted to collect identification signals sent by a plurality of different wireless controllers. Because of the wireless transmission structure, the method automatically switches the setting of the channel list within an authorized range. According to the identification codes corresponding to the received identification signals, the authorization ranges of a plurality of users are compared to provide an appropriate channel list for the viewers. In addition, the method allows users to set a plurality of different channel lists to achieve the purpose of diversity, protection, and convenience.

### CROSS-REFERENCE TO RELATED APPLICATION

This application claims the priority benefit of Taiwan application serial no. 94111616, filed on Apr. 13, 2005. All disclosure of the Taiwan application is incorporated herein by reference.

### BACKGROUND OF THE INVENTION

1. Field of Invention

The present invention relates to a method for channel control. More particularly, the present invention relates to a method for channel control with wireless transmission.

2. Description of the Related Art

With the prevalence of cable television, television channels have increased accordingly. Following that trend, appropriate channel list needs to be made for the viewers according to the program content, as the movie grading system aiming at different age groups. In a conventional technology, channel grading protection is provided by locking the code, wherein a more popular method is locking the fixed address code. That is, a signal processing technology is used to digitalize the video and audio information of a particular channel, and viewers must use a digital television receiver provided by the cable company to decode and then recover the signal. Thus, parents can set a password in the digital television receiver at home. Before watching the coded television program, the password must be entered, otherwise, this program cannot be viewed. In addition, some television sets have channel locking functions to provide similar protection measure.

However, aforesaid locking code technology can only be used to lock one set of channels, but cannot lock other channel combinations according to the viewer's preference. Moreover, the conventional technology is not convenient since passwords must be entered before watching the coded programs.

### SUMMARY OF THE INVENTION

The purpose of the present invention is directed to a method for channel control with wireless transmission, to determine the authorized range of accessible channels according to the identification codes corresponding to the identification signals sent by at least one wireless controller, and to provide a channel list of lowest authorization level according to the authorization level of identification code when a plurality of identification signals are received.

According to the aforesaid purpose, the present invention provides a method for channel control with wireless transmission, the method including: setting play authorization, receiving an identification signal, determining whether the identification code of this identification signal and the personal password are correct, if identification code and personal password are correct, then comparing authorization levels of all identification codes, and setting the channel list appointed by the identification code with lowest authorization level as play list.

According to a method for channel control with wireless transmission described in an embodiment of this invention, the method further includes setting and modifying play authorization, the steps of which include entering a system password, selecting channel list of identification code, and appointing authorization level for said identification code.

According to a method for channel control with wireless transmission described in an embodiment of this invention, wherein, in the step of setting play authorization, if a play authorization has been set, then a preset basic authorization is granted, if not, then all channels are accessible.

According to a method for channel control with wireless transmission described in an embodiment of this invention, wherein basic authorization includes appointing basic accessible channels, setting limits of channel accessible time, and closing all channels.

According to a method for channel control with wireless transmission described in an embodiment of this invention, wherein an identification signal is sent by a wireless controller, including bluetooth wireless transmission method.

The present invention provides a method for channel control with wireless transmission, the method including setting a play authorization, wherein the play authorization has a plurality of authorization levels, receiving at least one identification signal, wherein each identification signal contains a set of identification code, and each set of authorization code is corresponding to one of the authorization levels and a channel list, determining whether each identification code is correct, if each identification code is correct, then comparing authorization levels of all identification codes, and setting the channel list appointed by the identification code with the lowest authorization level as the play list.

Because the present invention adopts a multiple wireless transmission structure, the authorized range of accessible channels can be automatically switched and configured, and the authorized ranges of identification codes corresponding to identification signals sent by different wireless controllers can be compared, to provide appropriate channel list for viewers and achieve the purpose of grading protection.

The above and other features of the present invention will be better understood from the following detailed description of the embodiments of the invention that is provided in combination with the accompanying drawings

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic block diagram of a method for channel control with wireless transmission used in a device according to an embodiment of the present invention.

FIG. 2 is a flow chart of a method for channel control with wireless transmission according to the present invention.

FIG. 3 is a flow chart of setting and modifying a play authorization in a method for channel control with wireless transmission according to an embodiment of the present invention.

FIG. 4 is a schematic block diagram a method for channel control with wireless transmission used in a device according to another embodiment of the present invention.

### DESCRIPTION OF EMBODIMENTS

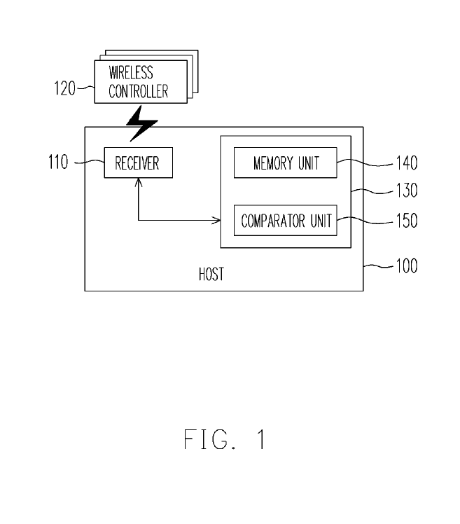

FIG. 1 is a schematic block diagram of a method for channel control with wireless transmission used in a device according to an embodiment of the present invention. The device uses the receiver 110 installed inside the host 100 to receive identification signals sent by different wireless controllers 120, wherein each identification signal contains an identification code, which is transmitted to the processor 130 inside host 100 for an identification procedure. Wherein, the host 100 further includes a memory unit 140, used to store channel list and authorization level corresponding to these identification code, and a comparator unit 150, used to compare authorization levels of these identification codes corresponding to the identification signals when receiver 110 receives identification signals sent by more than one wireless controller 120 simultaneously, and then the host 100 would play the channel list setting of identification code corresponding to the lowest authorization level. Wherein, the lowest authorization level refers to authorization of the smallest amount of accessible channels or protection level channels. The transmission method of aforesaid wireless controller 120 includes bluetooth wireless transmission method but is not limited thereto. One of ordinary skill in the art can adopt other wireless transmission method according to the actual requirement without departing from the spirit of the invention.

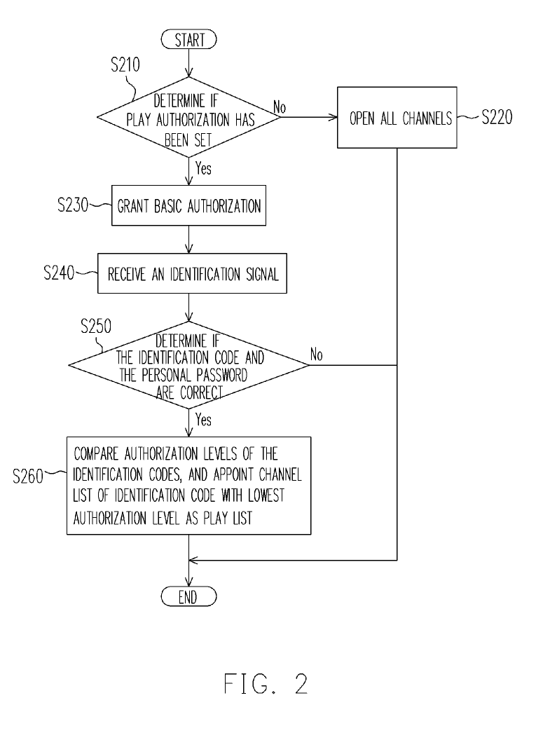

FIG. 2 is a flow chart of a method for channel control with wireless transmission according to the present invention. First, when booting the host, the processor determines whether the play authorization has been set yet (step S210). If play authorization has been set, then preset basic authorization is granted (step S230), and preset channels are allowed to play. If not, then all channels are open (step S220), then host receiver starts to receive the identification signals sent by the wireless controller (S240). When receiving at least one identification signal, the receiver performs an identification code confirmation process to determine whether the identification code and personal password are the same as the preset system password (step S250), wherein the identification code can come from SIM card (such as SIM card of cellular phone) or the identification code of bluetooth device. Or, users can enter their own passwords, and the method is not limited thereto. Users can adopt other methods to provide identification code according to the actual requirement without departing from the spirit of the invention. If no signal is received, then basic authorization and basic channels are granted, wherein the basic authorization includes designating accessible basic channels, setting time limits for channels, and closing all channels, etc., but the setting is not limited thereto. Users can adopt other setting for basic authorization according to the actual requirement without departing from the spirit of the invention. If personal password is determined to be correct, when receive a plurality of identification signals, the authorization levels of the identification codes corresponding to these identification signals are compared, and the channel list appointed by the identification code with lowest authorization level is provided to the host to limit the channels (step S260), wherein, considering the received identification signal may be designated by children or teenagers, in order to prevent them from violent, and sensational content, only the channel list with lowest authorization level is provided as play setting.

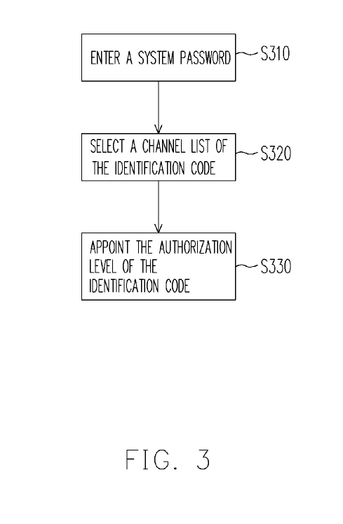

FIG. 3 is a flow chart of setting and modifying a play authorization in a method for channel control with wireless transmission according to an embodiment of the present invention. First, the user enters a system password (step S310), then the user selects a channel list corresponding to each identification code (step S320), wherein said channel list includes accessible channels and accessible input end list, such as connection to different input ends of personal computer, digital video disc. However, the channel list is not limited thereto. Users can adopt other kind of channel list according to the actual requirement without departing from the spirit of the invention. At last, the authorization level of the identification code is appointed to the user (step S330).

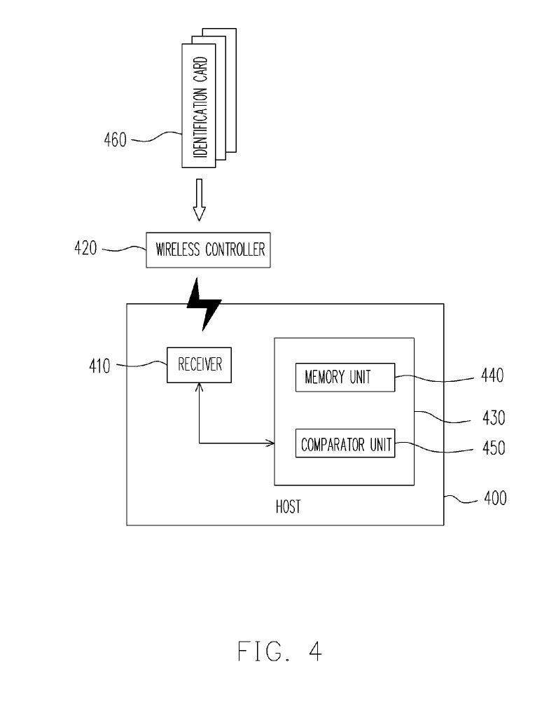

FIG. 4 is a schematic block diagram a method for channel control with wireless transmission used in a device according to another embodiment of the present invention. The device uses the receiver 410 installed inside the host 400 to receive identification signals sent by a wireless controller 420, wherein, a plurality of identification cards (such as SIM card of cellular phones) can be inserted to said wireless controller 420, and each identification card is corresponding to an identification code which is included in the identification signal transmitted to the processor 430 of the host 400 via the wireless controller 420 to proceed an identification procedure, wherein, the host 400 further includes a memory unit 440, used to store the channel list and authorization level corresponding to this identification code, and a comparator unit 450, used to compare authorization levels of the identification codes corresponding to the identification signals when the receiver 410 receives identification signals corresponding to a plurality of identification cards 460 sent by wireless controller 420 simultaneously, and then the host 400 would play the channel list setting of the identification code corresponding to the lowest authorization level. Wherein, the lowest authorization level refers to the authorization of the smallest amount of accessible channels or accessible protection level channels.

In conclusion, the method for channel control with wireless transmission in the present invention not only allows the user to set a plurality of channel lists, but also compares the authorization ranges designated by multiple users according to the identification code corresponding to the received identification signals, to provide an appropriate channel list for viewers, thereby achieving the purpose of diversity, protection, and convenience.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for channel control with wireless transmission, comprising the steps of:
a. receiving a plurality of identification signals by a receiver, each identification signal containing an identification code, and each identification code corresponding to one of a plurality of authorization levels and a channel list;
b. comparing if each identification code is the same as a system password by a processor; and
b1. if each identification code is the same as the system password, comparing an authorization level of each identification code by a comparator unit of said processor, and setting the channel list appointed by the identification code with lowest authorization level as play list;
b2. if partial identification code is the same as the system password, comparing the authorization level of the partial identification code, and setting the channel list appointed by the identification code with lowest authorization level as play list; and
b3. if none of the identification code is the same as the system password, the processor not opening any channel.

2. The method for channel control with wireless transmission as claimed in claim 1, wherein before step a, the method further comprises step a1, in which a play authorization is set and the play authorization has a plurality of authorization levels.

3. The method for channel control with wireless transmission as claimed in claim 2, wherein the step of setting play authorization comprises:
a11. entering the system password;
a12. selecting a channel list of the identification code; and
a13. designating an authorization level for the identification code.

4. The method for channel control with wireless transmission as claimed in claim 2, wherein if the play authorization has been set in the step of setting play authorization, the processor grants a preset basic authorization; if not, the processor opens all channels.

5. The method for channel control with wireless transmission as claimed in claim 4, wherein the basic authorization comprises appointing basic accessible channels.

6. The method for channel control with wireless transmission as claimed in claim 4, wherein the basic authorization comprises setting time limit for accessible channels.

7. The method for channel control with wireless transmission as claimed in claim 4, wherein the basic authorization comprises closing all channels.

8. The method for channel control with wireless transmission as claimed in claim 1, wherein the channel list comprises accessible channels.

9. The method for channel control with wireless transmission as claimed in claim 1, wherein the channel list comprises accessible input ends list.

10. The method for channel control with wireless transmission as claimed in claim 1, wherein the lowest authorization level refers to the authorization of the smallest amount of accessible channels or accessible protection level channels.

11. The method for channel control with wireless transmission as claimed in claim 1, wherein the identification signal is sent by a wireless controller.

12. The method for channel control with wireless transmission as claimed in claim 11, wherein the wireless controller comprises a bluetooth wireless transmission method and the identification code comprises an identification code of a bluetooth device.

13. The method for channel control with wireless transmission as claimed in claim 1, wherein the identification code comprises an identification code of SIM card.

14. The method for channel control with wireless transmission as claimed in claim 1, wherein the identification code comprises an identification code set by a user.

15. A method for channel control with wireless transmission, comprising the steps of:
a. receiving an identification signal by a receiver, the identification signal containing an identification code, and the identification code corresponding to one of a plurality of authorization levels and a channel list;
b. comparing if the identification code is the same as a system password by a processor; and
b1. if the identification code is correct, setting a channel list appointed by the identification code with the lowest authorization level as a play list by the processor; and
b2. if the identification codes is incorrect, the processor not opening any channel.

16. The method for channel control with wireless transmission as claimed in claim 15, wherein before step a, the method further comprises step a1, in which a play authorization is set and the authorization has a plurality of authorization levels.

17. The method for channel control with wireless transmission as claimed in claim 16, wherein the step of setting play authorization comprises:
a11. entering a system password;
a12. selecting a channel list of the identification code; and
a13. appointing an authorization level for the identification code.

18. The method for channel control with wireless transmission as claimed in claim 16, wherein if the play authorization has been set in the step of setting play authorization, the processor grants a preset basic authorization; if not, the processor opens all channels.

19. The method for channel control with wireless transmission as claimed in claim 18, wherein the basic authorization comprises appointing basic accessible channels.

20. The method for channel control with wireless transmission as claimed in claim 18, wherein the basic authorization comprises setting time limit for accessible channels.

21. The method for channel control with wireless transmission as claimed in claim 18, wherein the basic authorization comprises closing all channels.

22. The method for channel control with wireless transmission as claimed in claim 15, wherein the channel list comprises accessible channels.

23. The method for channel control with wireless transmission as claimed in claim 15, wherein the channel list comprises accessible input ends list.

24. The method for channel control with wireless transmission as claimed in claim 15, wherein the identification signal is sent by a wireless controller.

25. The method for channel control with wireless transmission as claimed in claim 15, wherein, the wireless controller comprises a bluetooth wireless transmission method and the identification code comprises an identification code of a bluetooth device.

26. The method for channel control with wireless transmission as claimed in claim 15, wherein the identification code comprises an identification code of SIM card.

27. The method for channel control with wireless transmission as claimed in claim 15, wherein the identification code comprises an identification code set by a user.
